(19) United States
(12) Patent Application Publication
(10) Pub. No.: US 2025/0227347 A1
(43) Pub. Date: Jul. 10, 2025

(54) ATSC 3.0-DELIVERED ALERTS FOR PEOPLE WITH ACCESSIBILITY NEEDS

(71) Applicant: Sony Group Corporation, TOKYO (JP)

(72) Inventors: Luke Fay, San Diego, CA (US); Christopher Szabo, San Diego, CA (US)

(21) Appl. No.: 18/404,808

(22) Filed: Jan. 4, 2024

(51) Int. Cl. H04N 21/81; H04N 21/258

(52) U.S. Cl. CPC H04N 21/814; H04N 21/25891

(57) ABSTRACT

Techniques are described for expanding and/or improving the Advanced Television Systems Committee (ATSC) 3.0 television protocol in robustly delivering the next generation broadcast television services. Advanced Emergency Alerts (AEA) are received via ATSC 3.0 and filtered according to end user desire. Signaling commences between the ATSC 3.0 receiver and nearby consumer electronic (CE) devices to cause the CE devices to activate to indicate to a person that he should access the ATSC 3.0 receiver to discern what AEA is being broadcast.

### FIELD

This application relates to technical advances necessarily rooted in computer technology and directed to digital television, and more particularly to Advanced Television Systems Committee (ATSC) 3.0.

### BACKGROUND

The Advanced Television Systems Committee (ATSC) 3.0 suite of standards is a set of over a dozen industry technical standards as indicated in “ATSC 3.0 System” (A/300) for delivering the next generation of broadcast television. ATSC 3.0 supports delivery of a wide range of television services including televised video, interactive services, non-real time delivery of data, and tailored advertising to a large number of receiving devices, from ultra-high definition televisions to wireless telephones. ATSC 3.0 also orchestrates coordination between broadcast content (referred to as “over the air”) and related broadband delivered content and services (referred to as “over the top”). ATSC 3.0 is designed to be flexible so that as technology evolves, advances can be readily incorporated without requiring a complete overhaul of any related technical standard. Present principles are directed to such advances as divulged below.

### SUMMARY

As understood herein, ATSC 3.0 provides for Advanced Emergency Alerts (AEA) that extend the Emergency Alert System (EAS) currently available in ATSC 1.0 (a.k.a broadcast HDTV) systems. Extra emergency information can be available to those with ATSC 3.0 devices. However, as understood herein people with sensory issues or other so-called “accessibility” needs may not be aware that an emergency alert and further information is being broadcast over their TVs. Furthermore, present principles understand that some people may not need to know about certain types of emergency alerts.

Accordingly, an ATSC 3.0 data structure such as an Advanced Emergency Alert Table (AEAT) may be used to receive AEA information, with a filter that may be defined by the end user filtering out AEAs from being presented that the user does not wish to see. Moreover, wireless signaling is used to convey the availability of AEAs to other consumer devices near the TV in the user's home so that these other devices, which may present information in a more perceptible form to the user, can activate and alert the user to access the TV to see the alert. For example, a deaf person may be able to see lights start to blink in response to the TV signaling new AEA information has arrived as an indicator to turn the TV on and see what AEA is available. As another example, a phone or other device of a blind person may be triggered to vibrate by the TV signaling new AEA information has arrived as an alert to access the TV and hear what AEA information is available. Accordingly, it is to be appreciated that present principles use consumer electronic (CE) devices other than the TV to alert a user to access the TV to discern the AEA being delivered. In specific examples, the signaling from the TV to these other CE devices may be via Bluetooth, Wi-Fi, digital personal assistant link, other smart IoT device communication links, etc.

Accordingly, a digital television apparatus includes at least one processor assembly programmed with instructions to receive at least one wakeup bit in an advanced television systems committee (ATSC) 3.0 bootstrap signal indicating availability of a digital television advanced emergency alert (AEA). The processor is programmed with instructions to signal (using ATSC A/338 standard or other means) to a first device other than the digital television apparatus to cause the first device to activate to indicate that the AEA is discernable on the digital television apparatus.

The AEA may be presented on at least one display according to user-defined filter information applied at a transmitter prior to sending AEAs. Or, the processor assembly can be programmed with instructions to present the AEA consistent with user-defined filter information. For example, amber alerts or school closings may not be of interest to the consumer, so those can be filtered out and will not trigger signaling to other CE devices.

In some examples the processor assembly can be programmed with instructions to present the AEA consistent with a user profile. The user profile can be automatically generated by accessing plural network sites to obtain information on a user associated with the digital television apparatus. Or, the user profile can be generated based on input from a user associated with the digital television apparatus.

In non-limiting embodiments the processor assembly can be programmed with instructions to present a first AEA of a first type according to user-defined filter information and not present a second AEA of a second type according to the user-defined filter information.

In non-limiting implementations the processor assembly can be programmed with instructions to identify, consistent with user information, the first device to signal the first device to activate to indicate that the AEA is discernable on the digital television apparatus. The user information can include an identification of the first device. In addition or alternatively, the user information can include an identification of an accessibility characteristic of a user and the processor assembly can be programmed with instructions to correlate the accessibility characteristic to the first device.

In another aspect, a digital television receiver includes at least one computer memory that is not a transitory signal and that in turn includes instructions executable by at least one processor assembly to present a first advanced emergency alert (AEA) on at least one display using filtering information. The instructions are executable to not present a second AEA on the display using filtering information. Further, the instructions are executable to signal to at least one consumer electronics (CE) device to indicate that the first AEA is accessible on the digital television receiver.

In another aspect, in a digital television system, a method includes receiving a first advanced emergency alert (AEA) at a digital television receiver, using the digital television receiver to signal to at least one consumer electronics (CE) device to indicate availability of the first AEA at the digital television receiver, and presenting the first AEA on at least one display associated with the digital television receiver.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 illustrates a block diagram of an Advanced Television Systems Committee (ATSC) 3.0 system;

FIG. 2 illustrates a block diagram showing components of the devices shown in FIG. 1;

FIG. 3 illustrates example overall logic in example flow chart format;

FIG. 4 illustrates first example AEA filtering logic in example flow chart format;

FIG. 5 illustrates second example AEA filtering logic in example flow chart format;

FIG. 6 illustrates first example user profile generation logic in example flow chart format;

FIG. 7 illustrates second example user profile generation logic in example flow chart format;

FIG. 8 illustrates an example screen shot of an example user interface (UI) for selecting or deselecting AEA presentation by AEA type;

FIG. 9 illustrates an example screen shot of another example UI for receiving user profile accessibility information that may be correlated to modes of AEA notification;

FIG. 10 illustrates an example screen shot of an example UI for receiving user profile notification information; and

FIG. 11 illustrates an example block diagram of example devices consistent with present principles.

### DETAILED DESCRIPTION

This disclosure relates to technical advances in digital television such as in Advanced Television Systems Committee (ATSC) 3.0 television. An example system herein may include ATSC 3.0 source components and client components, connected via broadcast and/or over a network such that data may be exchanged between the client and ATSC 3.0 source components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google, such as Android®. These operating environments may be used to execute one or more browsing programs, such as a browser made by Microsoft or Google or Mozilla or other browser program that can access websites hosted by the Internet servers discussed below.

ATSC 3.0 source components may include broadcast transmission components and servers and/or gateways that may include one or more processors executing instructions that configure the source components to broadcast data and/or to transmit data over a network such as the Internet. A client component and/or a local ATSC 3.0 source component may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security.

As used herein, instructions refer to computer-implemented steps for processing information in the system. Instructions can be implemented in software, firmware or hardware and include any type of programmed step undertaken by components of the system.

A processor may be a general-purpose single- or multi-chip processor that can execute logic by means of various lines such as address lines, data lines, and control lines and registers and shift registers. A processor assembly may include one or more processors.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library. While flow chart format may be used, it is to be understood that software may be implemented as a state machine or other logical method.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to hypertext markup language (HTML)-5, Java®/JavaScript, C # or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

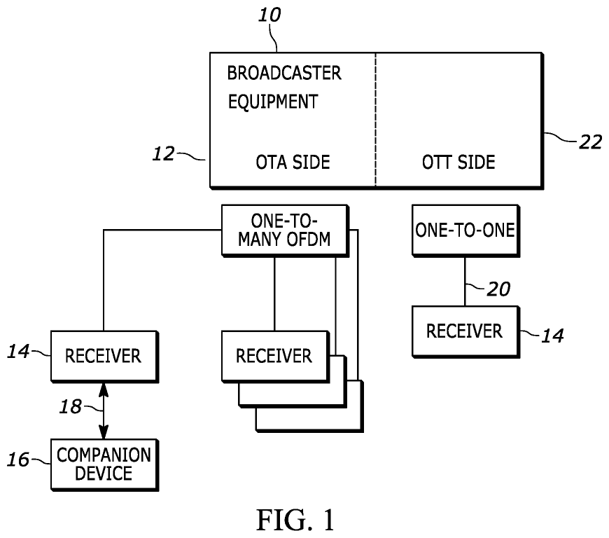

Turning to FIG. 1, an example of an ATSC 3.0 source component is labeled “broadcaster equipment” 10 and may include over-the-air (OTA) equipment 12 for wirelessly broadcasting, typically via orthogonal frequency division multiplexing (OFDM) in a one-to-many relationship, television data to plural receivers 14 such as ATSC 3.0 televisions. One or more receivers 14 may communicate with one or more companion devices 16 such as remote controls, tablet computers, mobile telephones, and the like over a short range, typically wireless link 18 that may be implemented by Bluetooth®, low energy Bluetooth, other near field communication (NFC) protocol, infrared (IR), etc.

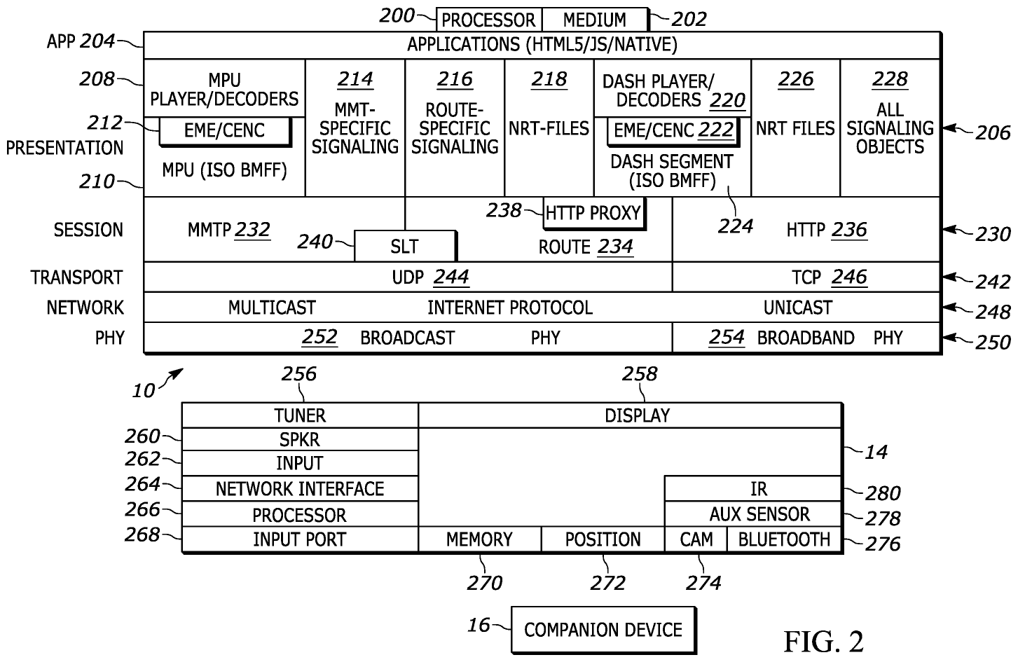

Also, one or more of the receivers 14 may communicate, via a wired and/or wireless network link 20 such as the Internet, with over-the-top (OTT) equipment 22 of the broadcaster equipment 10 typically in a one-to-one relationship. The OTA equipment 12 may be co-located with the OTT equipment 22 or the two sides 12, 22 of the broadcaster equipment 10 may be remote from each other and may communicate with each other through appropriate means. In any case, a receiver 14 may receive ATSC 3.0 television signals OTA over a tuned-to ATSC 3.0 television channel and may also receive related content, including television, OTT (broadband). Note that computerized devices described in all of the figures herein may include some or all of the components set forth for various devices in FIGS. 1 and 2.

Referring now to FIG. 2, details of examples of components shown in FIG. 1 may be seen. FIG. 2 illustrates an example protocol stack that may be implemented by a combination of hardware and software. Using the ATSC 3.0 protocol stack shown in FIG. 2 and modified as appropriate for the broadcaster side, broadcasters can send hybrid service delivery in which one or more program elements are delivered via a computer network (referred to herein as “broadband” and “over-the-top” (OTT)) as well as via a wireless broadcast (referred to herein as “broadcast” and “over-the-air” (OTA)). FIG. 2 also illustrates an example stack with hardware that may be embodied by a receiver.

Disclosing FIG. 2 in terms of broadcaster equipment 10, one or more processors 200 accessing one or more computer storage media 202 such as any memories or storages described herein may be implemented to provide one or more software applications in a top-level application layer 204. The application layer 204 can include one or more software applications written in, e.g., HTML5/JavaScript running in a runtime environment. Without limitation, the applications in the application stack 204 may include linear TV applications, interactive service applications, companion screen applications, personalization applications, emergency alert applications, and usage reporting applications. The applications typically are embodied in software that represents the elements that the viewer experiences, including video coding, audio coding and the run-time environment. As an example, an application may be provided that enables a user to control dialog, use alternate audio tracks, control audio parameters such as normalization and dynamic range, and so on.

Below the application layer 204 is a presentation layer 206. The presentation layer 206 includes, on the broadcast (OTA) side, broadcast audio-video playback devices referred to as Media Processing Units (MPU) 208 that, when implemented in a receiver, decode and playback, on one or more displays and speakers, wirelessly broadcast audio video content. The MPU 208 is configured to present International Organization for Standardization (ISO) base media file format (BMFF) data representations 210 and video in high efficiency video coding (HEVC) with audio in, e.g., Dolby audio compression (AC)-4 format. ISO BMFF is a general file structure for time-based media files broken into “segments” and presentation metadata. Each of the files is essentially a collection of nested objects each with a type and a length. To facilitate decryption, the MPU 208 may access a broadcast side encrypted media extension (EME)/common encryption (CENC) module 212.

FIG. 2 further illustrates that on the broadcast side the presentation layer 206 may include signaling modules, including either motion pictures expert group (MPEG) media transport protocol (MMTP) signaling module 214 or real-time object delivery over unidirectional transport (ROUTE) signaling module 216 for delivering non-real time (NRT) content 218 that is accessible to the application layer 204. NRT content may include but is not limited to stored replacement advertisements.

On the broadband (OTT or computer network) side, when implemented by a receiver the presentation layer 206 can include one or more dynamic adaptive streaming over hypertext transfer protocol (HTTP) (DASH) player/decoders 220 for decoding and playing audio-video content from the Internet. To this end the DASH player 220 may access a broadband side EME/CENC module 222. The DASH content may be provided as DASH segments 224 in ISO/BMFF format.

As was the case for the broadcast side, the broadband side of the presentation layer 206 may include NRT content in files 226 and may also include signaling objects 228 for providing play back signaling.

Below the presentation layer 206 in the protocol stack is a session layer 230. The session layer 230 includes, on the broadcast side, either MMTP protocol 232 or ROUTE protocol 234.

On the broadband side the session layer 230 includes HTTP protocol 236 which may be implemented as HTTP-secure (HTTP(S). The broadcast side of the session layer 230 also may employ a HTTP proxy module 238 and a service list table (SLT) 240. The SLT 240 includes a table of signaling information which is used to build a basic service listing and provide bootstrap discovery of the broadcast content. Media presentation descriptions (MPD) are included in the “ROUTE Signaling” tables delivered over user datagram protocol (UDP) by the ROUTE transport protocol.

A transport layer 242 is below the session layer 230 in the protocol stack for establishing low-latency and loss-tolerating connections. On the broadcast side the transport layer 242 uses (UDP 244 and on the broadband side transmission control protocol (TCP) 246.

The example non-limiting protocol stack shown in FIG. 2 also includes a network layer 248 below the transport layer 242. The network layer 248 uses Internet protocol (IP) on both sides for IP packet communication, with multicast delivery being typical on the broadcast side and unicast being typical on the broadband side.

Below the network layer 248 is the physical layer 250 which includes broadcast transmission/receive equipment 252 and computer network interface(s) 254 for communicating on the respective physical media associated with the two sides. The physical layer 250 converts Internet Protocol (IP) packets to be suitable to be transported over the relevant medium and may add forward error correction functionality to enable error correction at the receiver as well as contain modulation and demodulation modules to incorporate modulation and demodulation functionalities. This converts bits into symbols for long distance transmission as well as to increase bandwidth efficiency. On the OTA side the physical layer 250 typically includes a wireless broadcast transmitter to broadcast data wirelessly using orthogonal frequency division multiplexing (OFDM) while on the OTT side the physical layer 250 includes computer transmission components to send data over the Internet.

A DASH Industry Forum (DASH-IF) profile sent through the various protocols (HTTP/TCP/IP) in the protocol stack may be used on the broadband side. Media files in the DASH-IF profile based on the ISO BMFF may be used as the delivery, media encapsulation and synchronization format for both broadcast and broadband delivery.

Each receiver 14 typically includes a protocol stack that is complementary to that of the broadcaster equipment.

A receiver 14 in FIG. 1 may include, as shown in FIG. 2, an Internet-enabled TV with an ATSC 3.0 TV tuner (equivalently, set top box controlling a TV) 256. The receiver 14 may be an Android®-based system. The receiver 14 alternatively may be implemented by a computerized Internet enabled (“smart”) telephone, a tablet computer, a notebook computer, a wearable computerized device, and so on. Regardless, it is to be understood that the receiver 14 and/or other computers described herein is configured to undertake present principles (e.g. communicate with other devices to undertake present principles, execute the logic described herein, and perform any other functions and/or operations described herein).

Accordingly, to undertake such principles the receiver 14 can be established by some or all of the components shown in FIG. 1. For example, the receiver 14 can include one or more displays 258 that may be implemented by a high definition or ultra-high definition “4K” or higher flat screen and that may or may not be touch-enabled for receiving user input signals via touches on the display. The receiver 14 may also include one or more speakers 260 for outputting audio in accordance with present principles, and at least one additional input device 262 such as, e.g., an audio receiver/microphone for, e.g., entering audible commands to the receiver 14 to control the receiver 14. The example receiver 14 may further include one or more network interfaces 264 for communication over at least one network such as the Internet, a WAN, a LAN, a PAN etc. under control of one or more processors 266. Thus, the interface 264 may be, without limitation, a Wi-Fi transceiver, which is an example of a wireless computer network interface, such as but not limited to a mesh network transceiver. The interface 264 may be, without limitation, a Bluetooth® transceiver, Zigbee® transceiver, Infrared Data Association (IrDA) transceiver, Wireless USB transceiver, wired USB, wired LAN, Powerline or Multimedia over Coax Alliance (MoCA). It is to be understood that the processor 266 controls the receiver 14 to undertake present principles, including the other elements of the receiver 14 described herein such as, for instance, controlling the display 258 to present images thereon and receiving input therefrom. Furthermore, note the network interface 264 may be, e.g., a wired or wireless modem or router, or other appropriate interface such as, e.g., a wireless telephony transceiver, or Wi-Fi transceiver as mentioned above, etc.

In addition to the foregoing, the receiver 14 may also include one or more input ports 268 such as a high definition multimedia interface (HDMI) port or a USB port to physically connect (using a wired connection) to another CE device and/or a headphone port to connect headphones to the receiver 14 for presentation of audio from the receiver 14 to a user through the headphones. For example, the input port 268 may be connected via wire or wirelessly to a cable or satellite source of audio video content. Thus, the source may be a separate or integrated set top box, or a satellite receiver. Or, the source may be a game console or disk player.

The receiver 14 may further include one or more computer memories 270 such as disk-based or solid-state storage that are not transitory signals, in some cases embodied in the chassis of the receiver as standalone devices or as a personal video recording device (PVR) or video disk player either internal or external to the chassis of the receiver for playing back audio video (AV) programs or as removable memory media. Also, in some embodiments, the receiver 14 can include a position or location receiver 272 such as but not limited to a cellphone receiver, global positioning satellite (GPS) receiver, and/or altimeter that is configured to e.g. receive geographic position information from at least one satellite or cellphone tower and provide the information to the processor 266 and/or determine an altitude at which the receiver 14 is disposed in conjunction with the processor 266. However, it is to be understood that that another suitable position receiver other than a cellphone receiver, GPS receiver and/or altimeter may be used in accordance with present principles to determine the location of the receiver 14 in e.g. all three dimensions.

Continuing the description of the receiver 14, in some embodiments the receiver 14 may include one or more cameras 274 that may include one or more of a thermal imaging camera, a digital camera such as a webcam, and/or a camera integrated into the receiver 14 and controllable by the processor 266 to gather pictures/images and/or video in accordance with present principles. Also included on the receiver 14 may be a Bluetooth® transceiver 276 or other Near Field Communication (NFC) element for communication with other devices using Bluetooth® and/or NFC technology, respectively. An example NFC element can be a radio frequency identification (RFID) element.

Further still, the receiver 14 may include one or more auxiliary sensors 278 (such as a motion sensor such as an accelerometer, gyroscope, cyclometer, or a magnetic sensor and combinations thereof), an infrared (IR) sensor for receiving IR commands from a remote control, an optical sensor, a speed and/or cadence sensor, a gesture sensor (for sensing gesture commands) and so on providing input to the processor 266. An IR sensor 280 may be provided to receive commands from a wireless remote control. A battery (not shown) may be provided for powering the receiver 14.

The companion device 16 may incorporate some or all of the elements shown in relation to the receiver 14 described above.

The methods described herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the Internet.

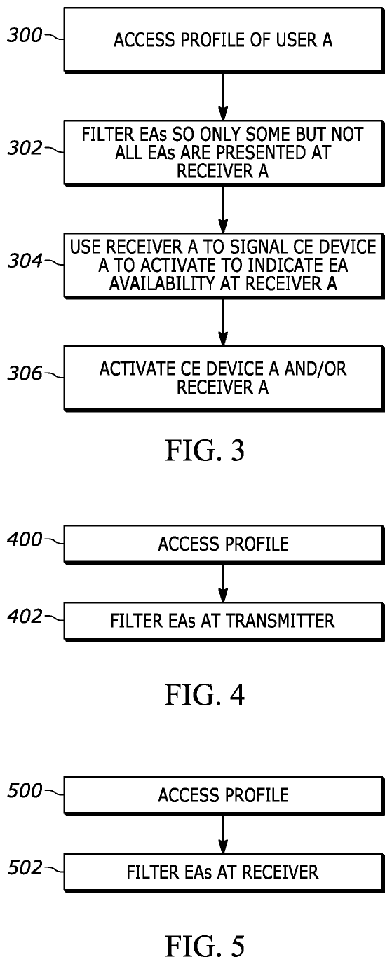

Prior to referring to FIG. 3, present principles understand that the ATSC 3.0 specification provides signaling for advanced emergency alerts (AEA) that includes data to help first responders and the public. ATSC 3.0 receivers can use a robust signaling bit to look for a new emergency alert table which lists current active alerts and pointers to further information.

In greater detail, the ATSC 3.0 signal contains a notification of emergency alerts as specified in A/321 (incorporated herein and part of the instant file history) wake-up bits sent in the ATSC 3.0 broadcast ‘bootstrap’ signal. Those bits are ‘ea_wake_up_1’ and ‘ea_wake_up_2’. If the bits are changing, then new emergency information is indicated as being available with an updated Advanced Emergency Alert Table (AEAT) as defined in A/331, incorporated herein and part of the instant file history. This data structure includes indications of AEA type, such as Emergency, Warning, Non-emergency public announcements, and Other. An example ATSC 3.0 AEA data structure is shown in the table below.

AEAT Element Structure

| Element or | | | |
|---|---|---|---|
| Attribute Name | Use | Data Type | Short Description |
| AEAT | | | Root element of the AEAT |
| AEA | 1 . . . N | | Advanced Emergency Alert formatted as AEA- |
| | | | MF. |
| @aeaId | 1 | string | The identifier of AEA message. |
| @issuer | 1 | string | The identifier of the broadcast station |
| | | | originating or forwarding the message. |
| @audience | 1 | string | The intended distribution of the AEA message. |
| @aeaType | 1 | string | The category of the message. |
| @refAEAId | 0 . . . 1 | string | The referenced identifier of AEA message. It |
| | | | shall appear when the @aeaType is “update” |
| | | | or “cancel” and shall not appear when the |
| | | | @aeaType is “alert”. |
| @priority | 0 . . . 1 | unsignedByte | The priority of the message. It shall appear |
| | | | when the @aeaType is “alert” or “update” and |
| | | | may appear when the @aeaType is “cancel”. |
| @wakeup | 0 . . . 1 | boolean | Indication that this AEA is associated with a |
| | | | wake-up event. |
| Header | 0 . . . 1 | | The container for the basic alert envelope. |
| @effective | 0 . . . 1 | dateTime | The effective time of the AEA message. It |
| | | | appears when the @aeaType is “alert” or |
| | | | “update.” If omitted, the default is immediate. |
| @expires | 0 . . . 1 | dateTime | The expiration time of the AEA message. It |
| | | | appears when the @aeaType is “alert” or |
| | | | “update”. |
| EventCode | 0 . . . 1 | string | A code identifying the event type of the AEA |
| | | | message. |
| @type | 0 . . . 1 | string | A national-assigned string designating the |
| | | | domain of the code (e.g. SAME in US, . . . ) |
| EventDesc | 0 . . . N | string | The short plain text description of the |
| | | | emergency event (e.g. “Tornado Warning” or |
| | | | “Tsunami Warning.” |
| @lang | 1 | lang | The code denoting the language of the |
| | | | respective element of the EventDesc. |
| Location | 0 . . . N | string | The geographic code delineating the affected |
| | | | area of the AEA message. It appears when the |
| | | | @aeaType is “alert” or “update” and can |
| | | | appear when the @aeaType is “cancel”. |
| @type | 1 | string | A national-assigned string designating the |
| | | | domain of the code (e.g. FIPS in US or “SGC” |
| | | | in Canada) |
| AEAText | 0 . . . N | string | Contains the specific text of the emergency |
| | | | notification. It appears when the @aeaType is |
| | | | “alert” or “update” and can appear when the |
| | | | @aeaType is “cancel”. |
| @lang | 1 | lang | The code denoting the language of the |
| | | | respective element of the AEA message text |
| LiveMedia | 0 . . . 1 | | Contains the information of emergency-related |
| | | | live A/V service which is delivered via |
| | | | broadcast stream. |
| @bsid | 1 | aeat:listOfUnsignedShort | Identifier of the Broadcast Stream contains the |
| | | | emergency-related live A/V service. |
| @serviceId | 1 | unsignedShort | Integer number that identifies the emergency- |
| | | | related A/V Service. |
| ServiceName | 0 . . . N | string | A user-friendly name for the service where the |
| | | | LiveMedia is available |
| @lang | 1 | lang | The language of the text described in the |
| | | | ServiceName element |
| Media | 0 . . . N | | Contains the component parts of the multimedia |
| | | | resource. |
| @lang | 0 . . . 1 | lang | The code denoting the language of the |
| | | | respective element Media |
| @mediaDesc | 0 . . . 1 | string | Text describing the type and content of the |
| | | | media file |
| @mediaType | 0 . . . 1 | string | Text identifying the intended use of the |
| | | | associated media. |
| @url | 1 | anyURI | URL of the media file |
| @alternateUrl | 0 . . . 1 | anyURI | Alternate URL of the media file when it is also |
| | | | available via non-broadcast delivery (i.e. via |
| | | | the Internet) |
| @contentType | 0 . . . 1 | string | IANA media type of media content referenced |
| | | | by Media@url |
| @contentLength | 0 . . . 1 | unsignedLong | Size in bytes of media content referenced by |
| | | | Media@url |
| @mediaAssoc | 0 . . . 1 | anyURI | URI of another Media element with which this |
| | | | attribute is associated |

As understood herein, for consumers with accessibility needs, an ATSC 3.0 receiver such as a TV can further signal the availability of advanced emergency alerts on the receiver to companion consumer electronic (CE) devices (e.g., as may be embodied by the companion device 16 in FIG. 1) such as networked room lights, radio, haptics feedback devices such as mobile phones to initiate behavior in the CE devices to indicate that an AEA is accessible on the ATSC 3.0 receiver. Thus, an ATSC 3.0 can, in accordance with present principles, act on the notification attribute @wakeup in the AEAT which indicates new emergency information is available and signal a CE device (another TV or display, radio, phone, car, light, etc.) of the incoming alert. These other CE devices can communicate with the ATSC 3.0 receiver via companion device communication protocols as specified in ATSC A/338 (incorporated herein by reference), or the connection can be to Alexa with an Alexa widget/skill, or other Internet of Things (IoT) device communication protocols that may use Wi-Fi, Bluetooth, or other wireless or wired protocol.

Refer now to FIG. 3. Commencing at state 300 a profile of a particular user (“A”) may be accessed to filter AEAs sent at state 302 via ATSC 3.0 to a receiver “A” associated with the user “A” so that some but not all AEAs are presented on the receiver “A”. The ATSC 3.0 signal accompanying the AEA can identify the start and duration, or start and end for the AEA. While FIG. 3 illustrates the case for one user, plural users associated with respective ATSC 3.0 receivers may be treated similarly.

Moving to state 304 the ATSC 3.0 receiver “A” is used to signal to other CE devices, e.g., nearby the receiver “A” in the user's home, to activate to indicate that an AEA is available for viewing/hearing on the receiver “A”. At state 306 the CE device(s) so signaled may be activated to generate an indication(s) to the user to access the AEA on the receiver “A”.

With this in mind, various use-cases may be implemented. An emergency signal can turn on the ATSC 3.0 receiver TV to provide alerts for people who are deaf or are low hearing. An emergency signal can turn on a nearby radio to provide alerts for people who are blind or have low vision. An emergency signal can turn on and/or blink the household lights and other physical notification devices to alert to provide alerts to people with accessibility needs.

FIGS. 4 and 5 illustrate implementation details relative to FIG. 3. At state 400 in FIG. 4 the profile of user “A” may be accessed by the transmitter which filters AEAs at the transmitter side for the user “A” according to the profile. Such transmitter-side filtering may include, e.g., removing the network address of the receiver “A” of the user “A” from an AEA transmission list for AEAs delivered OTT.

In addition or alternatively, at state 500 in FIG. 5 the profile of user “A” may be accessed by the receiver “A” to filters AEAs at the receiver side for the user “A” according to the profile. Such filtering may include not presenting AEAs on the receiver side and not signaling nearby CE devices of the presence of filtered AEAs. AEA types may be indicated in ATSC 3.0 signaling from the transmitter in the EventCode field of the data structure in the above table, or if filtering is done by intended target audience characteristics, by the Audience field in the data structure.

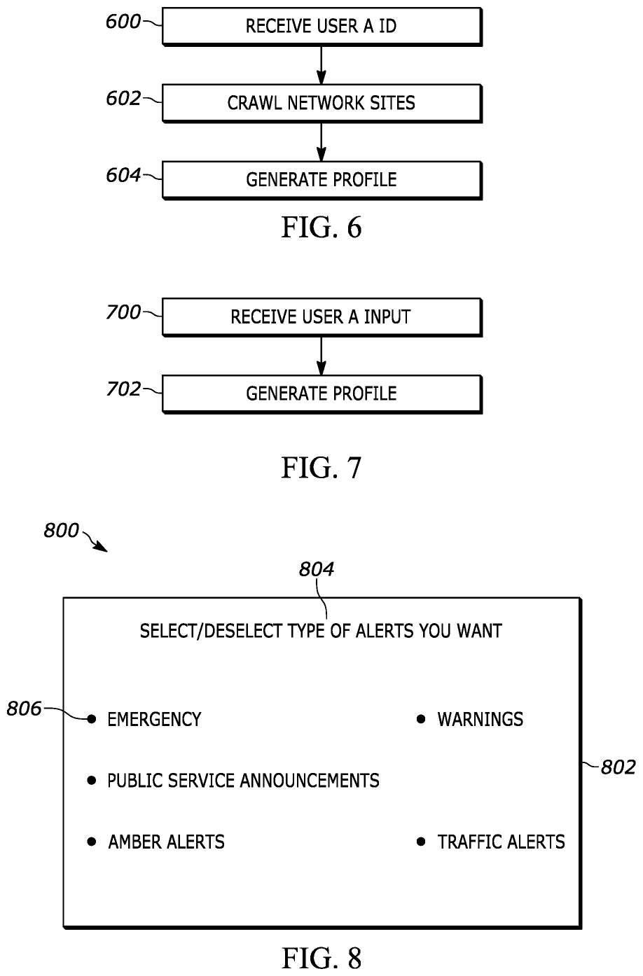

FIGS. 6 and 7 illustrate techniques for generating a user profile for use in FIGS. 3-5. Commencing at state 600 in FIG. 6, an identifier of the user “A” may be received. The identifier ma be a biometric-based detection signal of the user using face and/or voice recognition or other biometric technique, or a user name, or other identifier of the user. Moving to state 602, using the identifier from state 600 one or more processors such as server processors may crawl computer network sites for information pertaining to the user, such as any accessibility issues the user may have, with a profile for the user being generated accordingly at state 604.

In addition or alternatively, at state 700 direct input of personal information may be received from the user through, e.g., the ATSC 3.0 receiver input device, a mobile phone, or other input means, with a profile for the user being generated accordingly at state 702.

FIG. 8 illustrates a first user interface (UI) 800 that may be presented visibly and/or audibly and/or tactilely (visible embodiment shown) on any device herein such as any display apparatus 802 herein including an ATSC 3.0 display apparatus to enable a user to input profile information consistent with FIG. 7. The UI 800 may include a prompt 804 to select types of AEAs the user wishes to see, and/or equivalently to deselect types of AEAs the user does not wish to see. Selectors 806 respectively indicate AEA types to be presented (or not, depending on user selection/deselection). As shown, the types may include emergencies, warnings, public service announcements, Amber alerts, traffic alerts, and others.

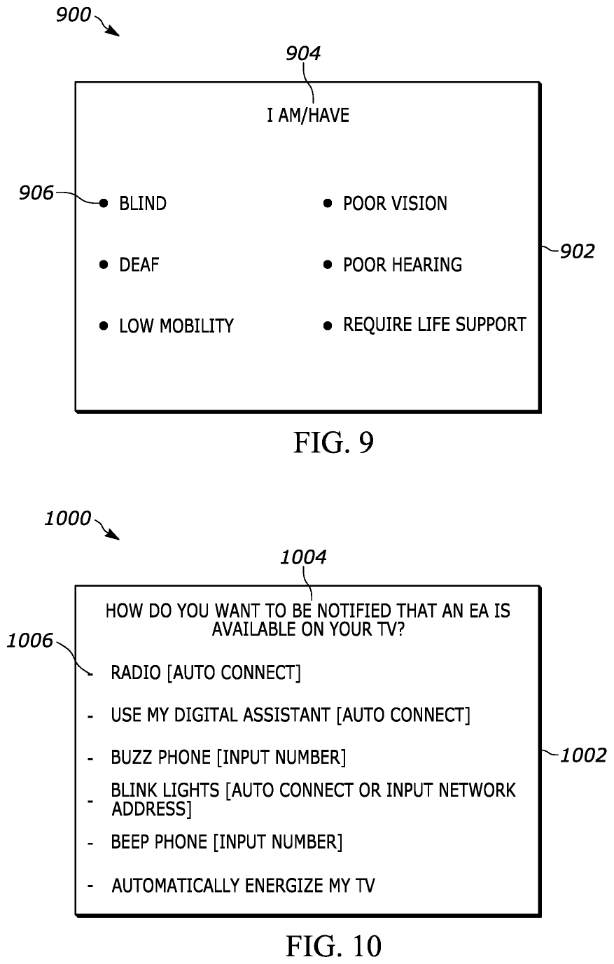

FIG. 9 illustrates a second example UI 900 that may be presented visibly and/or audibly and/or tactilely (visible embodiment shown) on any device herein such as any display apparatus 902 herein including an ATSC 3.0 display apparatus to enable a user to input profile information consistent with FIG. 7. The UI 900 may include a prompt 904 for the user to indicate any accessibility issues the user may have using one or more selectors 906 each associated with a particular accessibility issue. As shown, example accessibility issues may include being blind or generally having poor vision, being deaf or generally having poor hearing, having low physical mobility, and living with a person who requires life support.

When the UI 900 is employed, a processor assembly such as may be contained in an ATSC 3.0 receiver may correlate a selected accessibility issue to a nearby CE device to be activated when an AEA is received. For example, for users who selected deaf or poor hearing, this can be correlated to causing the ATSC 3.0 receiver TV to automatically energize when an AEA is received to provide alerts for such people who are deaf or are low hearing. As another example, for people who indicate they are blind or have low vision, this can be correlated to turning on a nearby radio or personal digital assistant discovered, e.g., using device discovery protocols over appropriate communication protocols, to provide alerts. Yet again, other accessibility issues may be correlated to turning on and/or blinking the household lights and other physical notification devices discovered using IoT communication protocol standards to alert people with accessibility needs.

Or, the above identification of which CE device to use to signal the availability of an AEA on the receiver may be implemented using a UI such as the UI 1000 in FIG. 10 which may be presented visibly and/or audibly and/or tactilely (visible embodiment shown) on any device herein such as any display apparatus 1002 herein including an ATSC 3.0 display apparatus to enable a user to input profile information consistent with Figures herein. The UI 1000 may include a prompt 1004 to instruct the user to select which CE device the user wants to use to indicate AEA availability on the ATSC 3.0 receiver. Selectors 1006 may be provided, one or more of which may be selected to specify a particular device and if desired the mode of AEA indication to be generated by that device. Examples include auto connecting to a radio to energize the radio, using a digital assistant via autoconnect protocols to announce an AEA is available on the receiver, buzzing a mobile phone whose telephone number may be input as shown, blinking lights via autoconnect protocols or by direct input of the IoT network address of the lights, beeping a mobile phone whose telephone number may be input as shown, and automatically energizing a TV to present the AEA. These are but examples of CE device selection for indication of AEAs available via an ATSC 3.0 receiver output device.

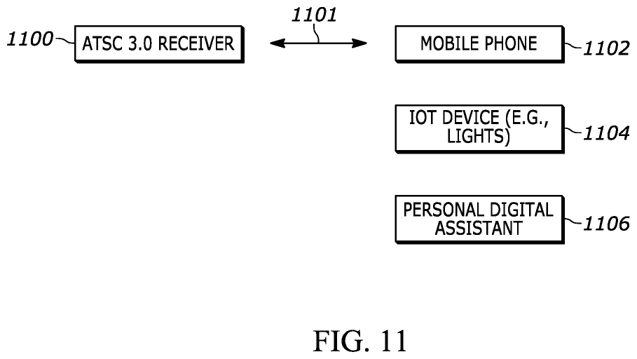

FIG. 11 illustrates interplay of such devices with an ATSC 3.0 receiver 1100 using wireless protocols 1101. One or more CE devices such as a mobile phone 1102, IoT device such as household lights 1104, and a personal digital assistant 1106 may communicate with the receiver 1100 to receive indications to activate to output alert respective signals indicating that an AEA is available for consumption via the ATSC 3.0 receiver (e.g., on a display associated with the receiver).

It will be appreciated that whilst present principals have been described with reference to some example embodiments, these are not intended to be limiting, and that various alternative arrangements may be used to implement the subject matter claimed herein.

What is claimed is:

1. A digital television apparatus comprising:
at least one processor assembly programmed with instructions to:
receive at least one wakeup bit in an advanced television systems committee (ATSC) 3.0 bootstrap signal indicating availability of a digital television advanced emergency alert (AEA); and
signal to a first device other than the digital television apparatus to cause the first device to react/respond in some way to indicate that the AEA is discernable on the digital television apparatus.

2. The digital television apparatus of claim 1, wherein the AEA is presented on at least one display according to user-defined filter information applied at a ATSC 3.0 receiver prior to signaling AEA availability.

3. The digital television apparatus of claim 1, wherein the processor assembly is programmed with instructions to present the AEA consistent with user-defined filter information.

4. The digital television apparatus of claim 1, wherein the processor assembly is programmed with instructions to present the AEA consistent with a user profile.

5. The digital television apparatus of claim 4, wherein the user profile is automatically generated by accessing plural network sites to obtain information on a user associated with the digital television apparatus.

6. The digital television apparatus of claim 4, wherein the user profile is generated based on input from a user associated with the digital television apparatus.

7. The digital television apparatus of claim 1, wherein the processor assembly is programmed with instructions to present a first AEA of a first type according to user-defined filter information and not present a second AEA of a second type according to the user-defined filter information.

8. The digital television apparatus of claim 1, wherein the processor assembly is programmed with instructions to identify, consistent with user information, the first device to signal the first device to react/respond in some way to indicate that the AEA is discernable on the digital television apparatus.

9. The digital television apparatus of claim 8, wherein the user information comprises an identification of the first device.

10. The digital television apparatus of claim 8, wherein the user information comprises an identification of an accessibility characteristic of a user and the processor assembly is programmed with instructions to correlate the accessibility characteristic to the first device.

11. A digital television receiver comprising:
at least one computer memory that is not a transitory signal and that comprises instructions executable by at least one processor assembly to:
present a first advanced emergency alert (AEA) on at least one display using filtering information;
not present a second AEA on the at least one display using filtering information; and
signal to at least one consumer electronics (CE) device to indicate that the first AEA is accessible on the digital television receiver.

12. The digital television receiver of claim 11, wherein the CE device comprises room lighting.

13. The digital television receiver of claim 11, wherein the CE device comprises a mobile phone.

14. The digital television receiver of claim 11, wherein the CE device comprises a digital personal assistant.

15. The digital television receiver of claim 11, wherein the filtering information indicates by type what AEAs are to be presented.

16. The digital television receiver of claim 11, wherein instructions are executable to the receive at least one wakeup bit in an advanced television systems committee (ATSC) 3.0 bootstrap signal indicating availability of the AEA.

17. In a digital television system, a method comprising:
receiving a first advanced emergency alert (AEA) at a digital television receiver;
using the digital television receiver to signal to at least one consumer electronics (CE) device to indicate availability of the first AEA at the digital television receiver; and
presenting the first AEA on at least one display associated with the digital television receiver.

18. The method of claim 17, comprising:
presenting the first AEA and not presenting a second AEA received by the digital television receiver according to filtering information.

19. The method of claim 18, comprising receiving an indication of AEA type in a digital television signal and using the indication of AEA type and the filtering information to determine whether to present an AEA associated with the AEA type.

20. The method of claim 17, comprising receiving at least one wakeup bit in an advanced television systems committee (ATSC) 3.0 bootstrap signal indicating availability of the AEA.
